(19) United States
(12) Patent Application Publication
(10) Pub. No.: US 2015/0112936 A1
(43) Pub. Date: Apr. 23, 2015

(54) BACKUP MANAGEMENT SYSTEM AND METHOD THEREOF

(71) Applicant: POWER-ALL NETWORKS LIMITED, Shatin (HK)

(72) Inventors: ZHI-HUI CAI, Shatin (CN); JUN LV, Shatin (CN); MENG-MING HUANG, Shatin (CN); JIAN-PING ZHANG, Shatin (CN)

(21) Appl. No.: 14/514,661

(22) Filed: Oct. 15, 2014

(30) Foreign Application Priority Data
Oct. 18, 2013 (CN) 201310493658.6

(51) Int. Cl. G06F 17/30; H04L 29/08; G06F 11/14

(52) U.S. Cl. CPC G06F 17/30088; G06F 11/1448; H04L 67/1097
USPC 707/639; 707/640

(57) ABSTRACT

A backup management system includes a backup management device and a number of electronic devices. Each of the electronic devices is in communication with the backup management device and with each other through a network. Each of the electronic devices includes at least one virtual machine. When one of the electronic devices needs to back up the at least one virtual machine, the electronic device sends a backup request to the backup management device. The backup management device instructs the electronic device to back up the at least one virtual machine to one of the other electronic devices.

### FIELD

The present disclosure relates to backup management systems and methods, and particularly to a backup management system and method for backing up a virtual machine of an electronic device.

### BACKGROUND

Data of an electronic device can be backed up. The backed up data can be used to restore data of the electronic device.

### BRIEF DESCRIPTION OF THE DRAWINGS

Implementations of the present technology will now be described, by way of example only, with reference to the attached figures.

FIG. 1 is a diagram of a first exemplary embodiment of a backup management system.

FIG. 2 is a block diagram of an exemplary embodiment of a backup management device of the backup management system.

FIG. 3 is a block diagram of an exemplary embodiment of a backup assistance system of the backup management device.

FIG. 4 is a block diagram of an exemplary embodiment of an electronic device of the backup management system.

FIGS. 5-6 are block diagrams of an exemplary embodiment of a backup implementation system of the electronic device.

FIG. 7 is a diagram of an exemplary embodiment of a backup management method.

FIG. 8 is a diagram of copying a logical volume of a virtual machine of a first electronic device to a second electronic device.

FIG. 9 is a diagram of a second exemplary embodiment of a backup management system.

FIGS. 10-13 are flowcharts of an exemplary embodiment of a backup management method.

FIG. 14 is a flowchart of an exemplary embodiment of a backup recovery method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Definitions that apply throughout this disclosure will now be presented.

The references “a plurality of” and “a number of” mean “at least two.”

The term “comprising,” when utilized, means “including, but not necessarily limited to”; it specifically indicates open-ended inclusion or membership in the so-described combination, group, series, and the like.

In general, the word “module” as used hereinafter refers to logic embodied in hardware or firmware, or to a collection of software instructions, written in a programming language such as, for example, but not limited to, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

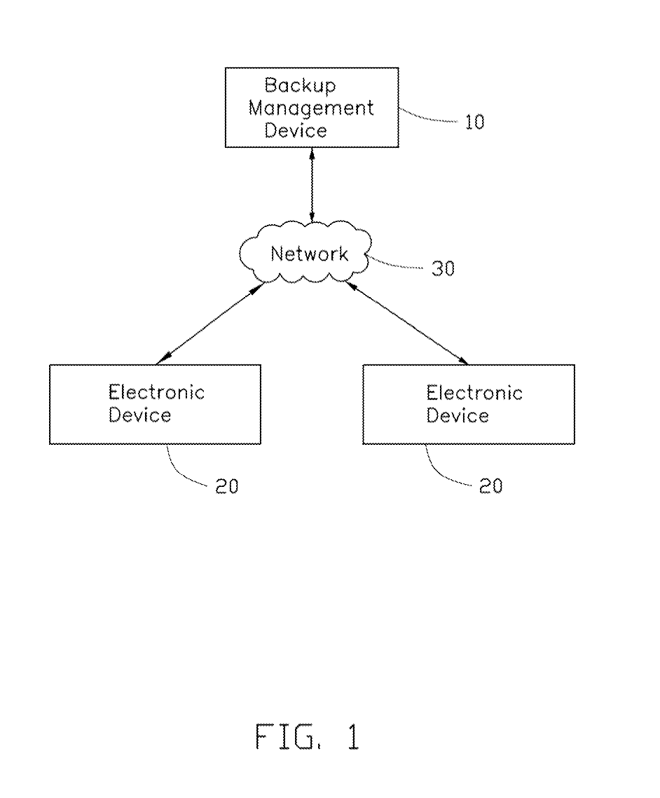

FIG. 1 illustrates a first example embodiment of a backup management system. In at least one embodiment, the backup management system can include a backup management device 10 and a plurality of electronic devices 20 (only two shown). Each electronic device 20 can communicate with the backup management device 10 through a network 30, and the electronic devices 20 can communicate with each other through the network 30. In at least one embodiment, each electronic device 20 can be a personal computer, a tablet computer, or any other suitable electronic device. The network 30 can be the Internet, a communication network, or a local area network based on BLUETOOTH, ZIGBEE, or WIFI, for example.

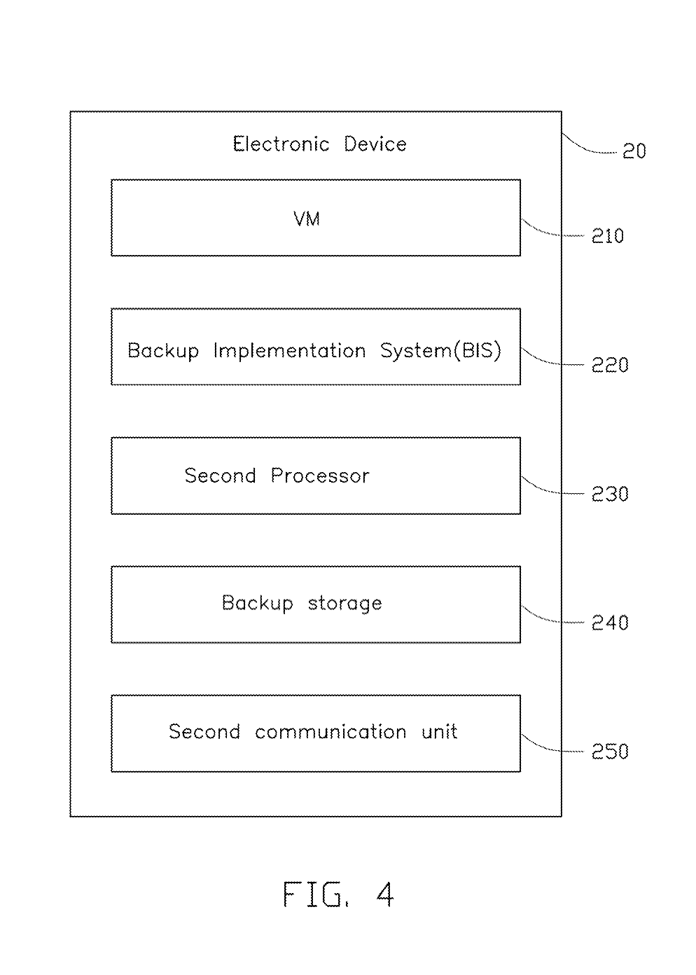

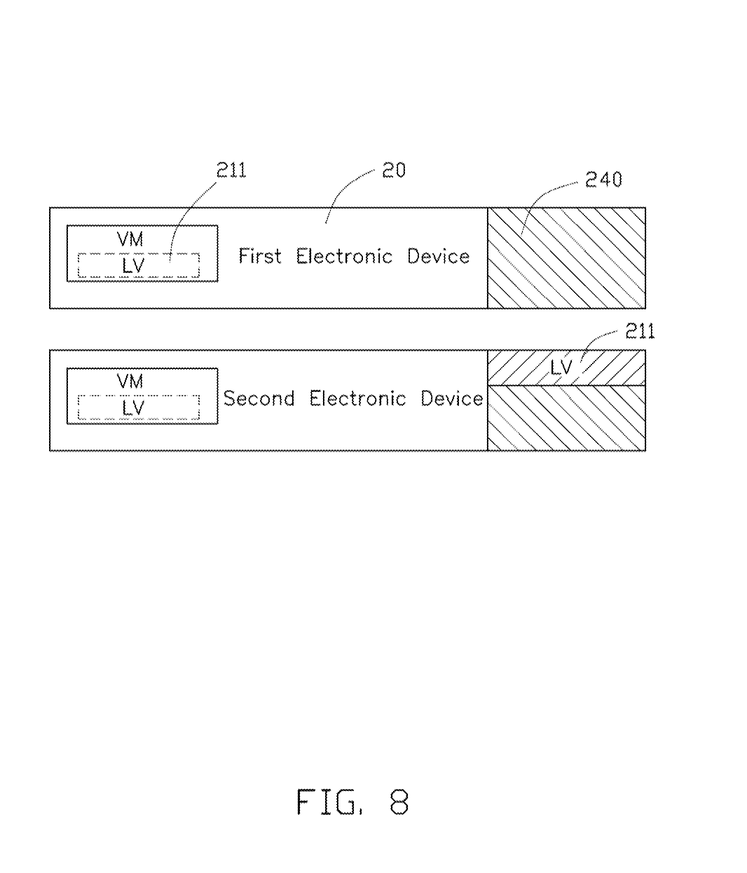

Each electronic device 20 can include a virtual machine (VM) 210 (shown in FIG. 4). Each VM 210 can include a plurality of logical volumes (LV) 211 (shown in FIG. 8, only one LV shown). In the backup management system, any electronic device 20 can back up the corresponding VM 210 to another electronic device 20. For simplicity and clarity of illustration, a process of backing up the VM 210 of a first electronic device 20 (shown in FIG. 8) to a second electronic device 20 (shown in FIG. 8) will be described. In at least one embodiment, the VM 210 of the first electronic device 20 can be backed up to the second electronic device 20 by copying the LV 211 of the VM 210 of the first electronic device 20 to the second electronic device 20.

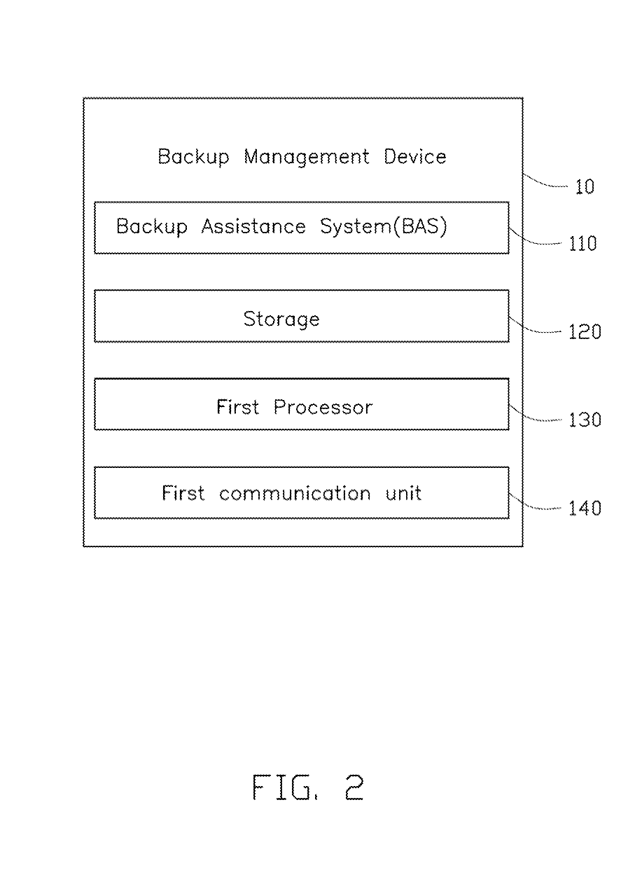

FIG. 2 illustrates an example embodiment of the backup management device 10. In at least one embodiment, the backup management device 10 can include a backup assistance system (BAS) 110, at least one storage 120, at least one first processor 130, and a first communication unit 140. The first communication unit 140 can be used to connect to the network 30. The BAS 110 can assist the first electronic device 20 in backing up the VM 210 to the second electronic device 20.

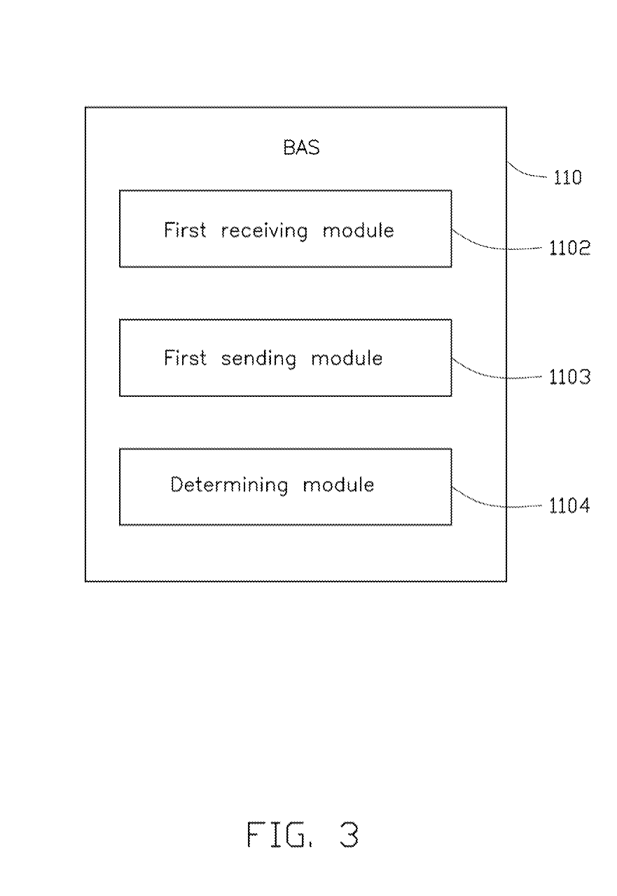

FIG. 3 illustrates an example embodiment of the BAS 110 of the backup management device 10. In at least one embodiment, the BAS 110 can include a plurality of modules, such as a first receiving module 1102, a first sending module 1103, and a determining module 1104. The plurality of modules of the BAS 110 can comprise one or more software programs in the form of computerized codes stored in the storage 120. The computerized codes can include instructions executed by the at least one first processor 130 to provide functions for the plurality of modules of the BAS 110.

The first receiving module 1102 can obtain information including a current amount of free space of each electronic device 20 at predetermined regular time intervals, and further receive a backup request from the first electronic device 20. The determining module 1104 can determine whether the VM 210 of the first electronic device 20 has been backed up before. If the determining module 1104 determines that the VM 210 of the first electronic device 20 has not been backed up before, the determining module 1104 determines which electronic device 20 of the other electronic devices 20 has a largest current amount of free space. The determining module 1104 designates the electronic device 20 having the largest current amount of free space as the second electronic device 20. After the determining module 1104 designates the second electronic device 20, the first sending module 1103 sends a first message to the first electronic device 20 instructing the first electronic device 20 to back up the VM 210 to the second electronic device 20. For example, the first message can include the designated second electronic device 20 and the current amount of free space of the second electronic device 20. When the VM 210 of the first electronic device 20 has been backed up previously, the determining module 1104 determines the second electronic device 20 where the VM 210 of the first electronic device 20 was backed up previously, and the first sending module 1103 sends a second message to the first electronic device 20 informing the first electronic device 20 that the VM 210 was backed up to the second electronic device 20 previously.

FIG. 4 illustrates an example embodiment of each electronic device 20. In at least one embodiment, each electronic device 20 can further include a backup implementation system (BIS) 220, a second processor 230, a backup storage 240, and a second communication unit 250. The second communication unit 250 can be used to connect to the network 30.

The BIS 220 can be used to back up the VM 210 of the first electronic device 20 to the backup storage 240 of the second electronic device 20.

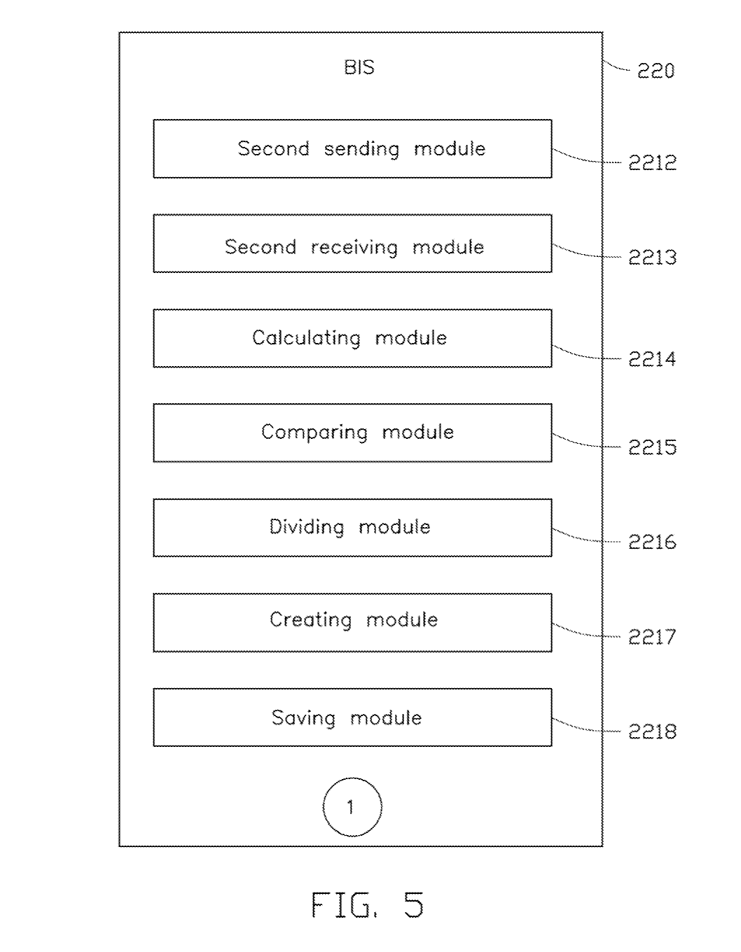

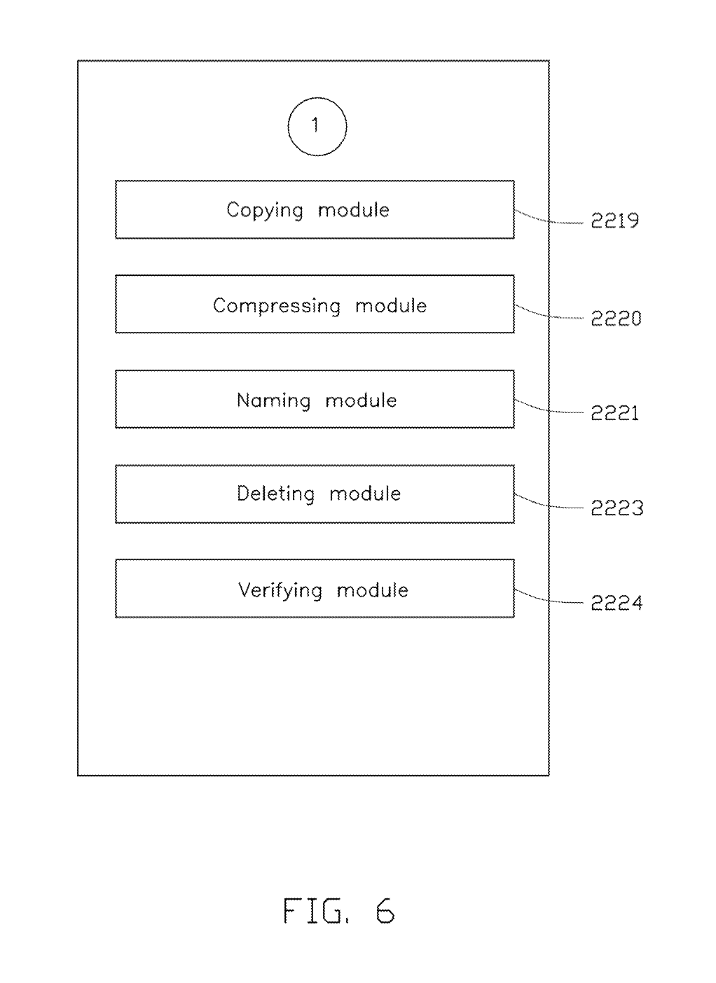

Referring to FIGS. 5-6, the BIS 220 can include a plurality of modules, such as a second sending module 2212, a second receiving module 2213, a calculating module 2214, a comparing module 2215, a dividing module 2216, a creating module 2217, a saving module 2218, and a copying module 2219. The plurality of modules of the BIS 220 can comprise one or more software programs in the form of computerized codes stored in the backup storage 240. The computerized codes can include instructions executed by the second processor 230 to provide functions for the plurality of modules of the BIS 220.

In at least one embodiment, the second sending module 2212 can send information including the current amount of free space to the first receiving module 1102 of the BAS 110, and further send the backup request to the first receiving module 1102 of the BAS 110. The second receiving module 2213 can receive the first message and the second message from the first sending module 1103 of the BAS 110.

The calculating module 2214 can calculate a required amount of space of the backup storage 240 of the second electronic device 20 to back up the VM 210 of the first electronic device 20. In detail, the calculating module 2214 first obtains a size of each LV 211 of the VM 210, and adds the sizes of all of the LVs 211 together to obtain a total size. The calculating module 2214 multiplies the total size by a compression ratio to obtain the required amount of backup space. For example, if the calculating module calculates the total size “total_size” and the compression ratio is 70%, the required amount of backup space “backup_space” is calculated by the following formula: backup_space=total size*70%.

The comparing module 2215 can compare whether the required amount of space is less than or equal to the current amount of free space of the backup storage 240 of the second electronic device 20. When the required amount of space is less than or equal to the current amount of free space, the VM 210 of the first electronic device 20 can continue to be backed up to the second electronic device 20. Otherwise, when the required amount of space is greater than the current amount of free space, the second sending module 2212 can send a message to a display (not shown) of the first electronic device 20 to inform a user that the VM 210 cannot be backed up.

The dividing module 2216 can divide each LV 211 into a plurality of files according to a predetermined rule. The creating module 2217 can create a temporary file from each file. For example, the temporary files can be of the form “*.img.gz” wherein “*” represents a serial order of creating the corresponding temporary file. The calculating module 2214 can further calculate an md5 value of each temporary file. The saving module 2218 can save each md5 value to the storage 120 of the backup management device 10. The copying module 2219 can copy each temporary file to the backup storage 240 of the second electronic device 20.

Referring to FIG. 6, the BIS 220 can further include a compressing module 2220, a naming module 2221, a deleting module 2223, and a verifying module 2224.

The naming module 2221 can assign an LV name to each LV 221 of the VM 210 before the dividing module 2216 divides each LV 221 into the plurality of files. The creating module 2217 can create a snapshot of each LV name. In at least one embodiment, the snapshot is a copy of data of the entire corresponding LV 221. The compressing unit 2220 can compress the temporary files before being copied to the backup storage 240 of the second electronic device 20. The deleting unit 2223 can delete the temporary files and the LV names from the first electronic device 20 after the temporary files are copied to the second electronic device 20.

When the VM 210 of the first electronic device 20 has been backed up to the second electronic device 20 previously, the calculating module 2214 can divide the plurality of files of the LVs 221 according to the predetermined rule. For example, the temporary files can be of the form “*.img” wherein “*” represents a serial order of creating the corresponding temporary file. After the calculating module 2214 calculates the md5 values of the temporary files, the comparing module 2215 can compare the md5 values of the temporary files to corresponding md5 values stored in the at least one storage 120 of the backup management device 10. When the md5 values of the temporary files are the same as the corresponding md5 values stored in the at least one storage 120 of the backup management device 10, the deleting module 2223 can delete the corresponding temporary files from the first electronic device 20. When the md5 values of the temporary files are different from the corresponding md5 values stored in the at least one storage 120 of the backup management device 10, the saving module 2218 can save the corresponding md5 values to the at least one storage 120 of the backup management device 10 to replace the corresponding md5 values that were saved previously, and the copying module 2219 can copy the corresponding temporary files to the backup storage 240 of the second electronic device 20 to replace the corresponding temporary files that were copied to the second electronic device 20 previously. For example, the compressing module 2220 can compress the temporary files “*.img” as “*.img.gz” to replace the corresponding temporary files in the backup storage 240 of the second electronic device 20. Thus, only data in the temporary files that have been changed are copied to the second electronic device 20, thereby decreasing a required amount of time and bandwidth to back up the VM 210 a second or more time.

When the first electronic device 20 needs to recover the backup of the VM 210, the second sending module 2212 of the first electronic device 20 can send a backup recovery request to the first receiving module 1102 of the backup management device 10. After the first receiving module 1102 receives the backup recovery request, the determining module 1104 can determine the second electronic device 20 where the VM 210 was backed up previously, and the first sending unit 1103 can send the second message to the second receiving module 2213. The copying module 2219 can copy the temporary files from the backup storage 240 of the second electronic device 20 to a logical volume manager (not shown) of the VM 210. The verifying module 2224 can verify the temporary files with the corresponding md5 values stored in the at least one storage 120 of the backup management device 10. After the temporary files are verified, the creating module 2217 can combine the temporary files in a sequence of copying the temporary files to the second electronic device 20, thereby recovering each LV 221 of the VM 210.

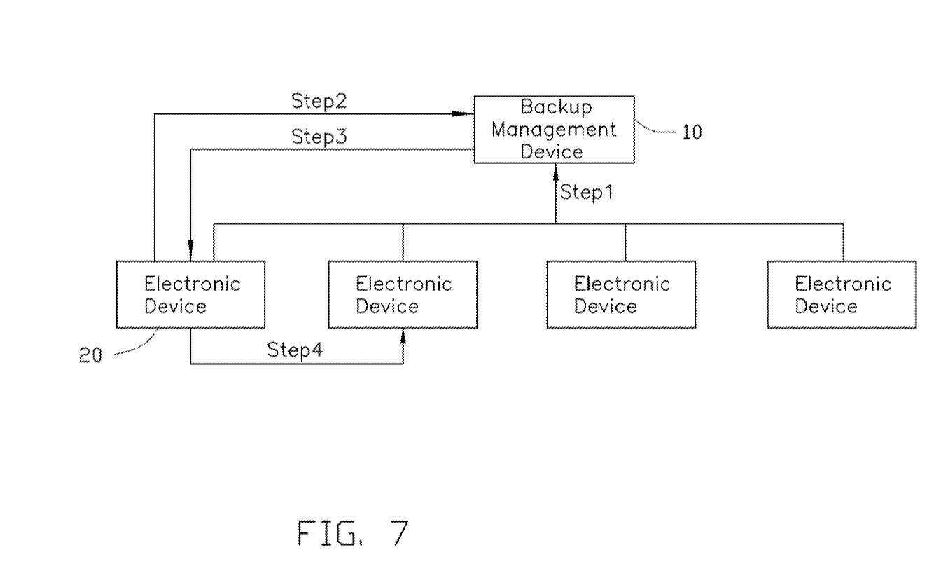

FIG. 7 illustrates a schematic diagram of an example embodiment of a process of the first electronic device 20 (shown in FIG. 8) backing up the VM 210 to the second electronic device 20 (shown in FIG. 8). In at least one embodiment, each electronic device 20 can first report information to the backup management device 10 at predetermined time intervals. The information can include a current amount of free space in the backup storage 240. Next, the first electronic device 20 can send a backup request to the backup management device 10 when the first electronic device needs to back up the VM 210. After the backup management device 10 receives the backup request from the first electronic device 20, the backup management device 10 can send a message to the first electronic device 20 to back up the VM 210 to the second electronic device 20. Finally, after receiving the message, the first electronic device 20 can back up the VM 210 to the second electronic device 20.

Referring to FIG. 8, the plurality of LVs 211 of the VM 211 of the first electronic device 20 can be copied to the backup storage 240 of the second electronic device 20.

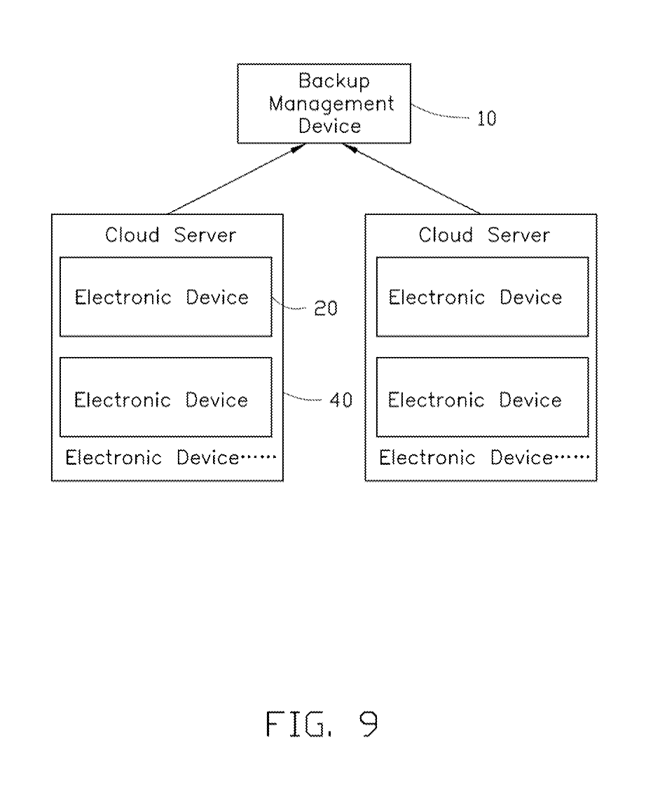

FIG. 9 illustrates a second embodiment of a backup management system. The backup management system of the second embodiment is similar to the backup management system of the first embodiment, except that the plurality of electronic devices 20 can be managed by one or more cloud servers 40. The plurality of electronic devices 20 can communicate with the backup management device 10 and with each other through the one or more cloud servers 40.

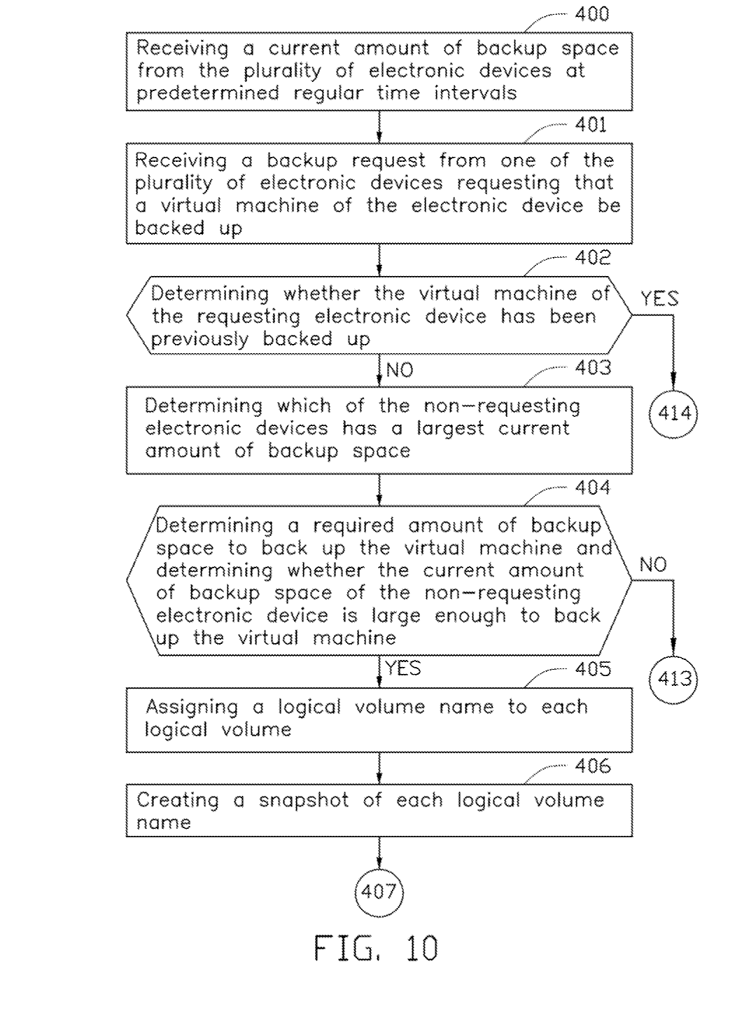

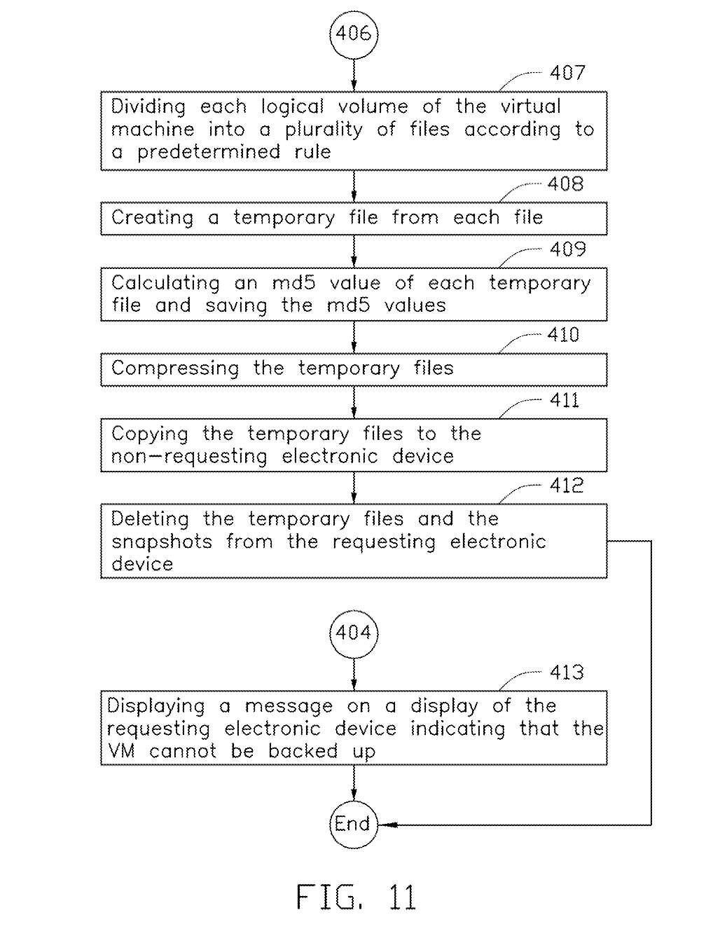

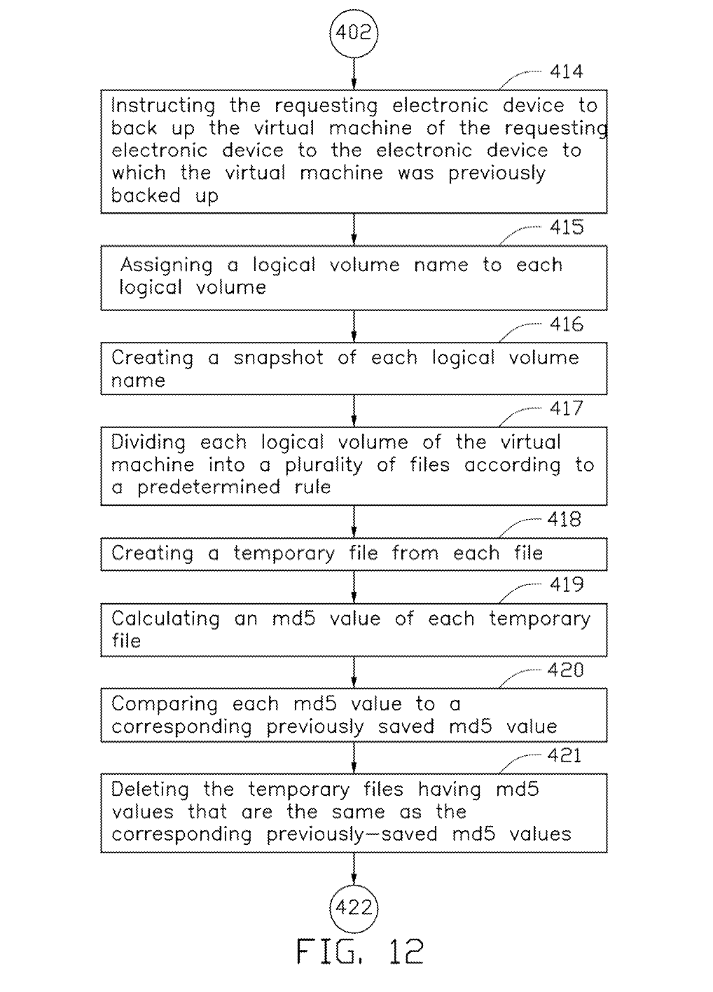

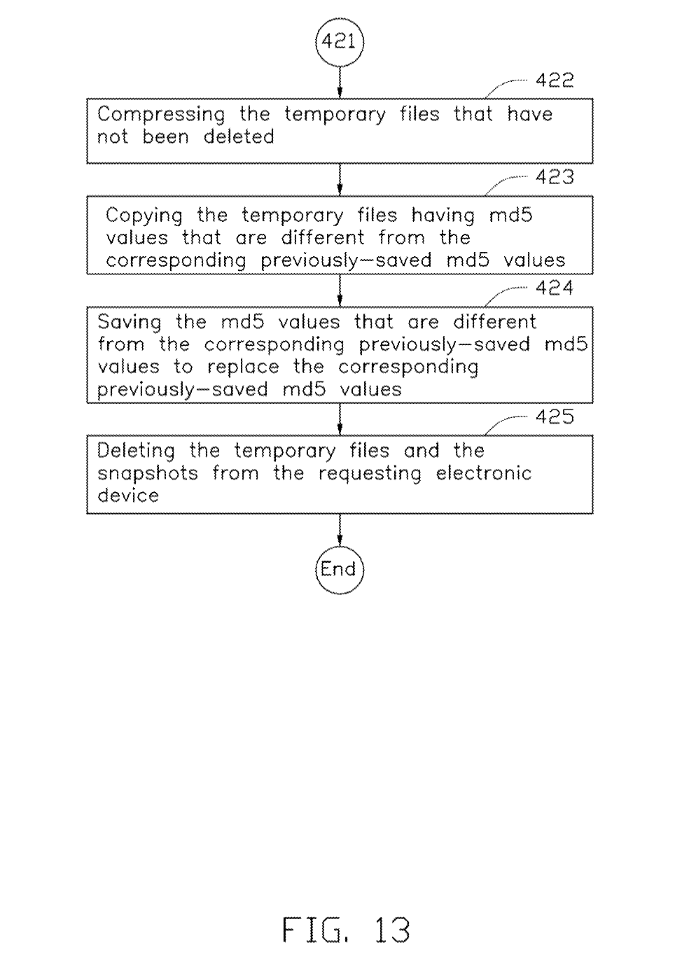

FIGS. 10-13 illustrate a flowchart of an example embodiment of a backup management method. The method is provided by way of example, as there are a variety of ways to carry out the method. The method described below can be carried out using the configurations illustrated in FIGS. 1-6, for example, and various elements of these figures are referenced in explaining the method. Each block shown in FIGS. 10-13 represents one or more processes, methods, or subroutines carried out in the method. Additionally, the illustrated order of blocks is by example only, and the order of the blocks can be changed.

The backup management method can begin at block 400.

At block 400, information including a current amount of free space of a plurality of electronic devices is obtained at predetermined regular time intervals.

At block 401, a backup request is received from one of the plurality of electronic devices requesting that a virtual machine (VM) of the electronic device be backed up.

At block 402, whether the VM of the requesting electronic device has been previously backed up is determined. If the VM has been previously backed up, block 414 is implemented. If the VM has not been previously backed up, block 403 is implemented.

At block 403, an electronic device of the non-requesting electronic devices having a largest current amount of backup space is determined.

At block 404, a required amount of space of the determined non-requesting electronic device to back up the VM and whether the required amount of space is large enough to back up the VM are determined. If the current amount of space of the non-requesting electronic device is not large enough, block 413 is implemented. If the current amount of backup space is large enough, block 405 is implemented.

At block 405, a logical volume (LV) name is assigned to each of a plurality of LVs of the VM.

At block 406, a snapshot of each LV name is created. In at least one embodiment, the snapshot is a copy of data of the entire corresponding LV.

At block 407, each LV of the VM is divided into a plurality of files according to a predetermined rule.

At block 408, a temporary file is created from each file.

At block 409, an md5 value of each temporary file is calculated and saved.

At block 410, the temporary files are compressed.

At block 411, the temporary files are copied to the non-requesting electronic device.

At block 412, the temporary files and the snapshots are deleted from the requesting electronic device, and then the method ends.

At block 413, a message indicating that the VM cannot be backed up is displayed on a display of the requesting electronic device.

At block 414, the requesting electronic device is instructed to back up the VM to the non-requesting electronic device where the VM was previously backed up.

At block 415, an LV name is assigned to each LV of the VM.

At block 416, a snapshot of each LV name is created. In at least one embodiment, the snapshot is a copy of data of the entire corresponding LV.

At block 417, each LV of the VM is divided into a plurality of files according to a predetermined rule.

At block 418, a temporary file is created from each file.

At block 419, an md5 value of each temporary file is calculated.

At block 420, each md5 value is compared to a corresponding previously saved md5 value.

At block 421, the temporary files having md5 values that are the same as the corresponding previously-saved md5 values are deleted.

At block 422, the temporary files that have not been deleted are compressed.

At block 423, the temporary files having md5 values that are different from the corresponding previously-saved md5 values are copied to the non-requesting electronic device.

At block 424, the md5 values that are different from the corresponding previously-saved md5 values are saved to replace the corresponding previously-saved md5 values.

At block 425, the temporary files and the snapshots are deleted from the requesting electronic device.

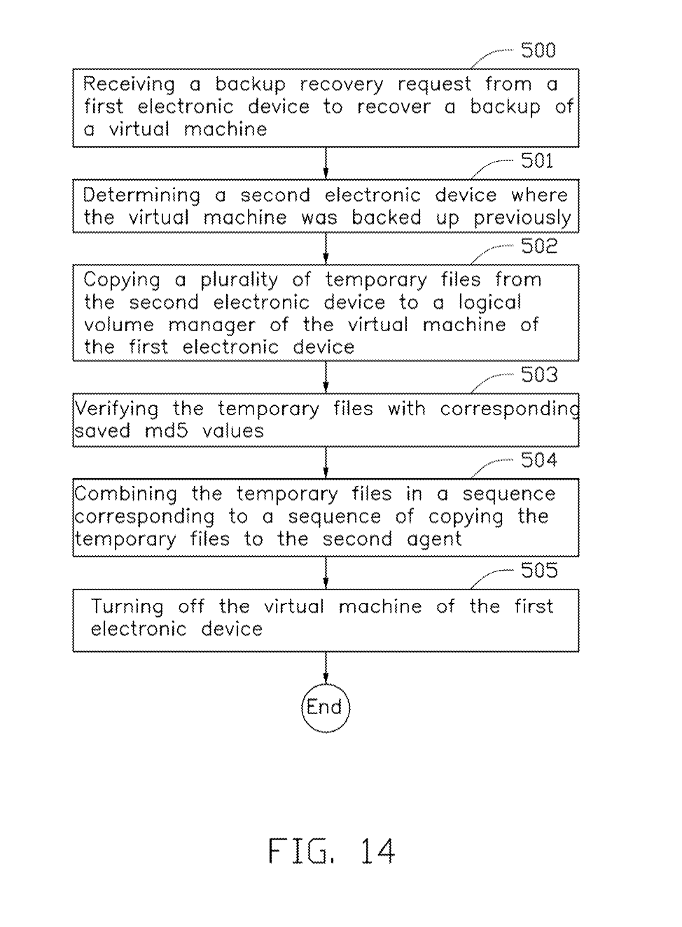

FIG. 14 illustrates a flowchart of an example embodiment of a backup recovery method. The method is provided by way of example, as there are a variety of ways to carry out the method. The method described below can be carried out using the configurations illustrated in FIGS. 1-6, for example, and various elements of these figures are referenced in explaining the method. Each block shown in FIG. 14 represents one or more processes, methods, or subroutines carried out in the method. Additionally, the illustrated order of blocks is by example only, and the order of the blocks can be changed. The backup recovery method can begin at block 500.

At block 500, a first electronic device sends a backup recovery request of a virtual machine (VM) to a backup management device.

At block 501, the backup management device determines a second electronic device where the VM was backed up to before.

At block 502, the first electronic device copies temporary files of logical volumes (LVs) of the VM to a logical volume manager of the VM.

At block 503, the first electronic device verifies the temporary files with corresponding md5 values stored in the backup management device.

At block 504, the first electronic device combines the temporary files in a sequence corresponding to a sequence of copying the temporary files to the second electronic device, thereby recovering the LVs of the VM.

At block 505, the first electronic device turns off the VM.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A backup management device comprising:
a first communication unit configured to communicate with a plurality of electronic devices through a network, each of the plurality of electronic devices comprising a second communication unit to communicate with the first communication unit; and
at least one processor configured to execute a plurality of instructions, the instructions to provide functions to a plurality of modules, the plurality of modules comprising:
a receiving module configured to receive a backup request from one of the electronic devices when a virtual machine of the electronic device needs to be backed up; and
a sending module configured to send a message to the requesting electronic device, the message instructing the requesting electronic device to back up the virtual machine to a non-requesting electronic device.

2. The backup management device as in claim 1, further comprising a determining module configured to determine whether the virtual machine of the requesting electronic device has been backed up previously; when the virtual machine has not been backed up previously, the determining module determines a non-requesting electronic device having a largest current amount of free space, and sends a message to the requesting electronic device to instruct the requesting electronic device to back up the virtual machine to the non-requesting electronic device having the largest current amount of free space; when the virtual machine has been backed up previously, the determining module determines the non-requesting electronic device where the virtual machine was backed up previously, and sends a message to the requesting electronic device to instruct the requesting electronic device to back up the virtual machine to the non-requesting electronic device where the virtual machine was backed up previously.

3. The backup management device as in claim 2, wherein each of the plurality of electronic devices reports the current amount of free space to the receiving module at predetermined time intervals.

4. A backup management system comprising:
a backup management device configured to instruct each of a plurality of electronic devices how to back up a virtual machine (VM) to another electronic device;
wherein the electronic devices are in communication with the backup management device and with each other through a network.

5. The backup management system as in claim 4, wherein the plurality of electronic devices is managed by one or more cloud servers, and the electronic devices communicate with the backup management device and with each other through the one or more cloud servers.

6. The backup management system as described in claim 4, wherein the backup management device comprises a backup assistance system (BAS), at least one storage, at least one first processor, and a first communication unit; the backup manager communicates with the network through the first communication unit; each electronic device further comprises a backup implementation system (BIS), a backup storage, at least one second processor, and a second communication unit; each electronic device communicates with the network through the second communication unit; and the BAS instructs each electronic device in backing up the at least one VM to another electronic device.

7. The backup management system as in claim 6, wherein the BAS comprises a first receiving module and a first sending module; the BIS comprises a second sending module and a second receiving module; the second sending module sends information to the first receiving module at predetermined time intervals, the information comprising a current amount of free space of the backup storage of the electronic device; when one of the electronic devices needs to back up the VM, the second sending module of a requesting electronic device sends a backup request of the at least one VM to the first receiving module; the first sending module sends a message to the second receiving module of the requesting electronic device, the message instructing the requesting electronic device how to back up the at least one VM.

8. The backup management system as in claim 7, wherein the BAS further comprises a determining module able to determine whether the at least one VM of the requesting electronic device has been backed up previously; the first sending module sends a first message to the second receiving module of the requesting electronic device when the determining module determines that the at least one VM has not been backed up previously, the first message instructing the requesting electronic device to back up the at least one VM to a non-requesting electronic device having a largest current amount of free space of all the non-requesting electronic devices; the first sending module sends a second message to the second receiving module of the requesting electronic device when the determining module determines that the at least one VM has been backed up previously, the second message informing the requesting electronic device the non-requesting electronic device where the at least one VM was backed up previously.

9. The backup management system as in claim 8, wherein the BIS further comprises a dividing module, a calculating module, a creating module, a saving module, and a copying module; the at least one VM of each electronic device comprises a plurality of logical volumes (LVs); the dividing module divides each LV into a plurality of files according to a predetermined rule; the creating module creates a temporary file from each file; the calculating module calculates an md5 value of each temporary file; the saving module saves each md5 value to the at least one storage of the backup manager; and the copying module copies each temporary file to the backup storage of the non-requesting electronic device.

10. The backup management system as in claim 9, wherein the BIS further comprises a compressing module, a naming module, a deleting module, and a comparing module;
when the VM has not been backed up previously, the calculating module of the requesting electronic device calculates a required amount of space for backing up the at least one VM to the non-requesting electronic device; the compressing module compresses the plurality of temporary files before the temporary files are copied to the non-requesting electronic device; the naming module assigns an LV name to each LV before the LV is divided into the plurality of files; the creating module creates a snapshot of each LV name, the snapshot being a copy of the data of the entire logical volume; the comparing module compares the md5 value of each temporary file to a corresponding md5 value saved in the at least one storage of the backup manager when the at least one VM has been backed up previously; the deleting module deletes the temporary files from the requesting electronic device after the temporary files have been copied to the backup storage of the non-requesting electronic device.

11. The backup management system as in claim 10, wherein the BIS further comprises a verifying module; when the requesting electronic device needs to recover the backup of the at least one VM from the non-requesting electronic device, the verifying module verifies the temporary files backed up to the non-requesting electronic device with the corresponding md5 values saved in the at least one storage of the backup manager.

12. A backup management method for an electronic device comprising:
receiving at predetermined regular time intervals from a plurality of electronic devices, a current amount of free space of each of the plurality of electronic devices;
receiving a backup request from one of the plurality of electronic devices requesting that a virtual machine of the electronic device be backed up;
determining whether the virtual machine of the requesting electronic device has been previously backed up;
determining which of the non-requesting electronic devices has a largest current amount of free space, if the virtual machine of the requesting electronic device has not been previously backed up;
instructing the requesting electronic device to back up the virtual machine of the requesting electronic device to the non-requesting electronic device with the largest current amount of free space upon determining that the virtual machine of the requesting device has not been previously backed up; and
instructing the requesting electronic device to back up the virtual machine of the requesting electronic device to the non-requesting electronic device where the virtual machine was previously backed up, upon determining that the virtual machine of the requesting electronic device has been previously backed up.

13. The backup management method as in claim 12, further comprising:
upon determining that the virtual machine has not been previously backed up, determining a required amount of space to back up the virtual machine of the requesting electronic device;
backing up the virtual machine to the non-requesting electronic device with the largest current amount of free space, upon determining that the current amount of free space of the non-requesting electronic device is large enough to back up the virtual machine; and
instructing the requesting electronic device to display a message indicating that the current amount of free space of the non-requesting electronic device is not large enough to back up the virtual machine of the requesting electronic device, upon determining that the current amount of free space of the non-requesting electronic device is not large enough to back up the virtual machine of the requesting electronic device.

14. The backup management method as in claim 13, wherein the required amount of space is determined by acquiring a total size of logical volumes of the virtual machine, and multiplying the total size of the logical volumes by a compression ratio.

15. The backup management method as in claim 14, further comprising:
dividing each logical volume of the virtual machine into a plurality of files according to a predetermined rule, upon determining that the current amount of free space of the non-requesting electronic device is large enough to back up the virtual machine of the electronic device;
creating a temporary file from each file;
calculating an md5 value of each temporary file and saving the md5 values; and
copying the temporary files to the non-requesting electronic device.

16. The backup management method as in claim 15, further comprising:
assigning a logical volume name to each logical volume before each logical volume is divided into the plurality of files;
creating a snapshot of each logical volume name, the snapshot being a copy of data of the entire logical volume;
compressing the temporary files before the temporary files are copied to the non-requesting electronic device; and
deleting the temporary files and the snapshots from the requesting electronic device after the temporary files have been copied.

17. The backup management method as in claim 12, further comprising:
upon determining that the virtual machine has been previously backed up, dividing each logical volume of a plurality of logical volumes of the virtual machine into a plurality of files according to a predetermined rule;
creating a temporary file from each file;
calculating an md5 value of each temporary file;
comparing each md5 value to a corresponding previously saved md5 value;
deleting the temporary files having md5 values that are the same as the corresponding previously-saved md5 values;
copying the temporary files having md5 values that are different from the corresponding previously-saved md5 values to the non-requesting electronic device where the virtual machine was previously backed up to replace the corresponding previously copied temporary files; and
saving the md5 values that are different from the corresponding previously-saved md5 values to replace the corresponding previously-saved md5 values.

18. The backup management method as in claim 17, further comprising:
assigning a logical volume name to each logical volume before each logical volume is divided into the plurality of files;
creating a snapshot of each logical volume name, the snapshot being a copy of data of the entire logical volume;
compressing the temporary files before the temporary files are copied to the non-requesting electronic device where the virtual machine was previously backed up;
and
deleting the temporary files and the snapshots from the requesting electronic device after the temporary files have been copied.

19. The backup management method as in claim 16, further comprising:
receiving a backup recovery request from the requesting electronic device to recover a backup of the virtual machine;
determining the non-requesting electronic device where the virtual machine was backed up previously;
copying the plurality of temporary files from the non-requesting electronic device to a logical volume manager of the virtual machine of the requesting electronic device;
verifying the temporary files with the corresponding saved md5 values;
combining the temporary files in a sequence corresponding to a sequence of copying the temporary files to the non-requesting electronic device; and
turning off the virtual machine of the requesting electronic device.

20. The backup management method as in claim 18, further comprising:
receiving a backup recovery request from the requesting electronic device to recover a backup of the virtual machine;
determining the non-requesting electronic device where the virtual machine was backed up previously;
copying the plurality of temporary files from the non-requesting electronic device to a logical volume manager of the virtual machine of the requesting electronic device;
verifying the temporary files with the corresponding saved md5 values;
combining the temporary files in a sequence corresponding to a sequence of copying the temporary files to the non-requesting electronic device; and
turning off the virtual machine of the requesting electronic device.
